(19) United States
(12) Patent Application Publication
(10) Pub. No.: US 2009/0010584 A1
(43) Pub. Date: Jan. 8, 2009

(54) BEARING ASSEMBLY

(76) Inventors: Sei-Joo Jang, Seoul (KR); Gyu-Seop Hyun, Gyeongi-do (KR)

Correspondence Address: JOHN J. ELNITSKI, JR., 225 A SNOWBIRD LANE, BELLEFONTE, PA, 16823, US

(21) Appl. No.: 11/835,581

(22) Filed: Aug. 8, 2007

(30) Foreign Application Priority Data
Jul. 4, 2007 (KR) 10-2007-0054204

(51) Int. Cl. F16C 33/32

(52) U.S. Cl. 384/492

(57) ABSTRACT

The present invention is a bearing assembly for a support frame and shaft with a shoulder. The bearing assembly includes balls. There is an outer race frame with a race to receive balls. The outer race frame is adapted to be mounted to the support frame. There is an inner race frame with a race to receive the balls. The inner race frame is adapted to be mounted to a shaft with a shoulder. The inner race frame and the outer race frame connect together to encase the balls. The inner race frame and the outer race frame together form an outside diameter measurement value and inside diameter measurement value of the bearing assembly. The inner race includes a shoulder surface contact area to be in contact with the shoulder which is at least ninety-five percent of thickness area of the bearing assembly.

This application claims the benefit of KR Patent Application 10-2007-0054204 filed Jun. 4, 2007,

### BACKGROUND

High quality bearing assemblies are very important to the operation of high speed rotating equipment such as motors and turbines. Bearing assemblies are used very extensively in all rotating motion machinery. Bearing assemblies help reduce the friction and stabilize vibration between the load and the rotating power sources of a motor or turbine. Many high quality bearing assemblies were available commercially, such as ball bearing assemblies, thrust bearing assemblies, and angular bearing assemblies. For high speed rotation applications with a heavy load, the stability of bearing assemblies becomes extremely important factor. There are problems with stability with current bearing assemblies and most times a bushing must be used with the bearing assemblies. This is because the industry uses standardized sizes for outside diameter (OD) and inside diameter (ID) of a bearing assembly. Where the OD is the diameter size that the bearing assembly is pressed into in a support frame to retain the bearing assembly and where the ID is the diameter that a shaft is pressed into to support the shaft. In order to reduce size and weight of the bearing assembly, the race frames of the bearing assembly have minimal contact with support frames for the bearing assembly and minimal contact with the shaft used with the bearing assembly. If one can enhance the quality of existing bearing assemblies even by a little to improve stability, the impact on the improvement of efficiency of machine can be enormous.

It is an object of the present invention to provide a bearing assembly with improved stability.

### SUMMARY OF INVENTION

The present invention is a bearing assembly for a support frame and shaft with a shoulder. The bearing assembly includes balls. There is an outer race frame with a race to receive balls. The outer race frame is adapted to be mounted to the support frame. There is an inner race frame with a race to receive the balls. The inner race frame is adapted to be mounted to a shaft with a shoulder. The inner race frame and the outer race frame connect together to encase the balls. The inner race frame and the outer race frame together form an outside diameter measurement value and inside diameter measurement value of the bearing assembly. The inner race includes a shoulder surface contact area to be in contact with the shoulder which is at least ninety-five percent of thickness area of the bearing assembly.

### BRIEF DESCRIPTION OF DRAWINGS

FIG. 1 is a cross-sectional view of a prior art ball bearing assembly.

FIG. 2 is a cross-sectional view of a prior art thrust bearing assembly.

FIG. 3 is a cross-sectional view of a prior art angular bearing assembly.

FIG. 4 is a schematic view of a normal load and angle α of the normal load for the ball bearing assembly of FIG. 1.

FIG. 5 is a schematic view of a normal load and angle α of the normal load for the thrust bearing assembly of FIG. 2.

FIG. 6 is a schematic view of a normal load and angle α of the normal load for the angular bearing assembly of FIG. 3.

FIG. 7 is a cross-sectional view of ball bearing assembly of FIG. 1 mounted in a support frame with shaft and shoulder.

FIG. 8 is a cross-sectional view of thrust bearing assembly of FIG. 2 mounted in a support frame with shaft and shoulder.

FIG. 9 is a cross-sectional view of angular bearing assembly of FIG. 3 mounted in a support frame with shaft and shoulder.

FIG. 10 is a cross-sectional view of a bearing assembly according to the present invention.

FIG. 11 is a schematic view of a normal load and angle α of the normal load for a bearing assembly according to the present invention.

FIG. 12 is a cross-sectional view of a bearing assembly according to the present invention mounted in a support frame with shaft and shoulder.

FIG. 13 is a cross-sectional view of a bearing assembly according to the present invention.

FIG. 14 is a schematic view of a normal load and angle α of the normal load for a bearing assembly according to the present invention.

FIG. 15 is a cross-sectional view of a bearing assembly according to the present invention mounted in a support frame with shaft and shoulder.

FIG. 16 is a cross-sectional view of a bearing assembly according to the present invention.

FIG. 17 is a schematic view of a normal load and angle α of the normal load for a bearing assembly according to the present invention.

FIG. 18 is a cross-sectional view of a bearing assembly according to the present invention mounted in a support frame with shaft and shoulder.

FIG. 19 is a cross-sectional view of a bearing assembly according to the present invention.

FIG. 20 is a schematic view of a normal load and angle α of the normal load for a bearing assembly according to the present invention.

FIG. 21 is a cross-sectional view of a bearing assembly according to the present invention mounted in a support frame with shaft and shoulder.

FIG. 22 is a cross-sectional view of a bearing assembly according to the present invention.

FIG. 23 is a schematic view of a normal load and angle α of the normal load for a bearing assembly according to the present invention.

FIG. 24 is a cross-sectional view of a bearing assembly according to the present invention mounted in a support frame with shaft and shoulder.

FIG. 25 is a cross-sectional view of a bearing assembly according to the present invention.

FIG. 26 is a schematic view of a normal load and angle α of the normal load for a bearing assembly according to the present invention.

FIG. 27 is a cross-sectional view of a bearing assembly according to the present invention mounted in a support frame with shaft and shoulder.

FIG. 28 is a cross-sectional view of a bearing assembly according to the present invention.

FIG. 29 is a schematic view of a normal load and angle α of the normal load for a bearing assembly according to the present invention.

FIG. 30 is a cross-sectional view of a bearing assembly according to the present invention mounted in a support frame with shaft and shoulder.

FIG. 31 is a cross-sectional view of a bearing assembly according to the present invention.

FIG. 32 is a schematic view of a normal load and angle α of the normal load for a bearing assembly according to the present invention.

FIG. 33 is a cross-sectional view of a bearing assembly according to the present invention mounted in a support frame with shaft and shoulder.

### DETAIL DESCRIPTION OF INVENTION

The present invention provides an enhanced stability for a bearing assembly. The improvements presented by the present invention allows the use of standardized OD and ID values. The energy loss due to the vibration of a bearing assembly can be reduced significantly by stabilizing bearing assembly. The bearing assembly is stabilized by increasing the contact areas between outside of the bearing race frames of the bearing assembly and the mounting areas of the bearing assembly, as compared to existing bearings. Whereby, the mounting areas are the support frame for the bearing assembly and the rotating load attached to the bearing assembly. The rotating load is commonly a shaft which rotates with an inner race frame, whereby the shaft includes a shoulder surface. The bearing race frames include the races which rotate about the bearing balls. The present invention also provides a bearing race frames with an angled surface to reduce vibration due to instability. The bearing assembly of the present invention allows the stress of the normal load on the balls of the bearing assembly where the balls contact the races of the race frames to be distributed over a wider area in the bearing assembly by making contact area with the mounting area wider. The stress of the normal load, T, is defined by F/S, where F is the force due to the normal load and S is the contact area between race of bearings frame and normal load. The stress of the normal load to the balls of the bearing assembly can be distributed over wider angles by designing the angle to avoid a ninety degree load between the stress direction and the tangential direction at the contact point between the ball and the race of the race frame. Distributing the stress of the normal load in this manner increases the stability of the bearing assembly.

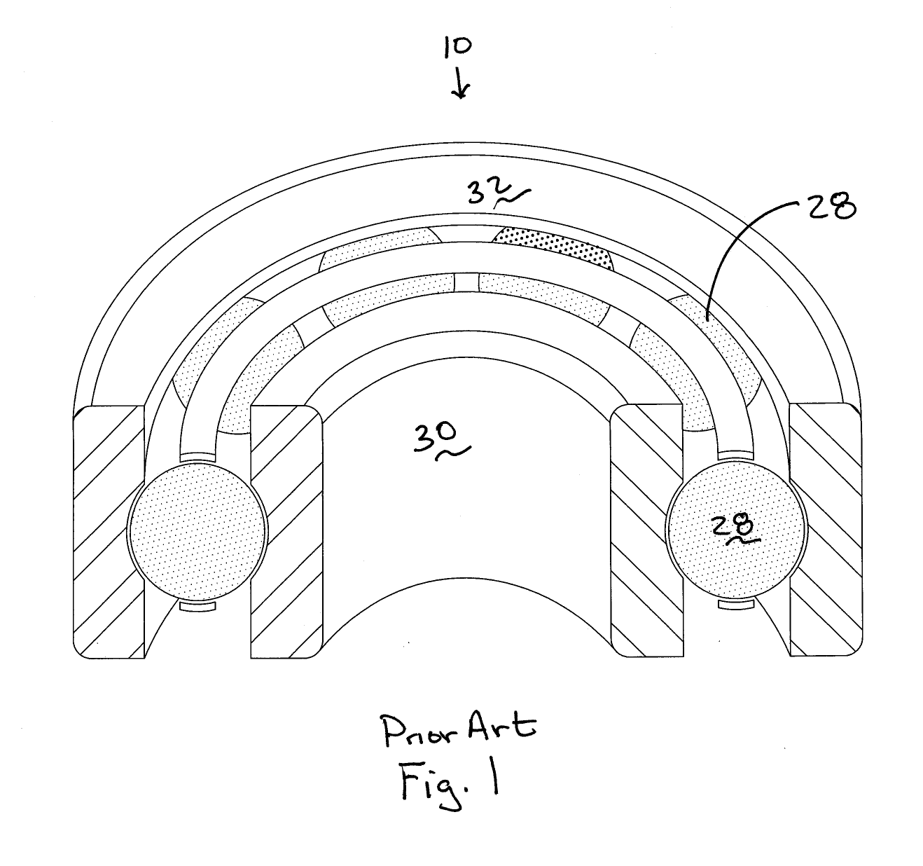

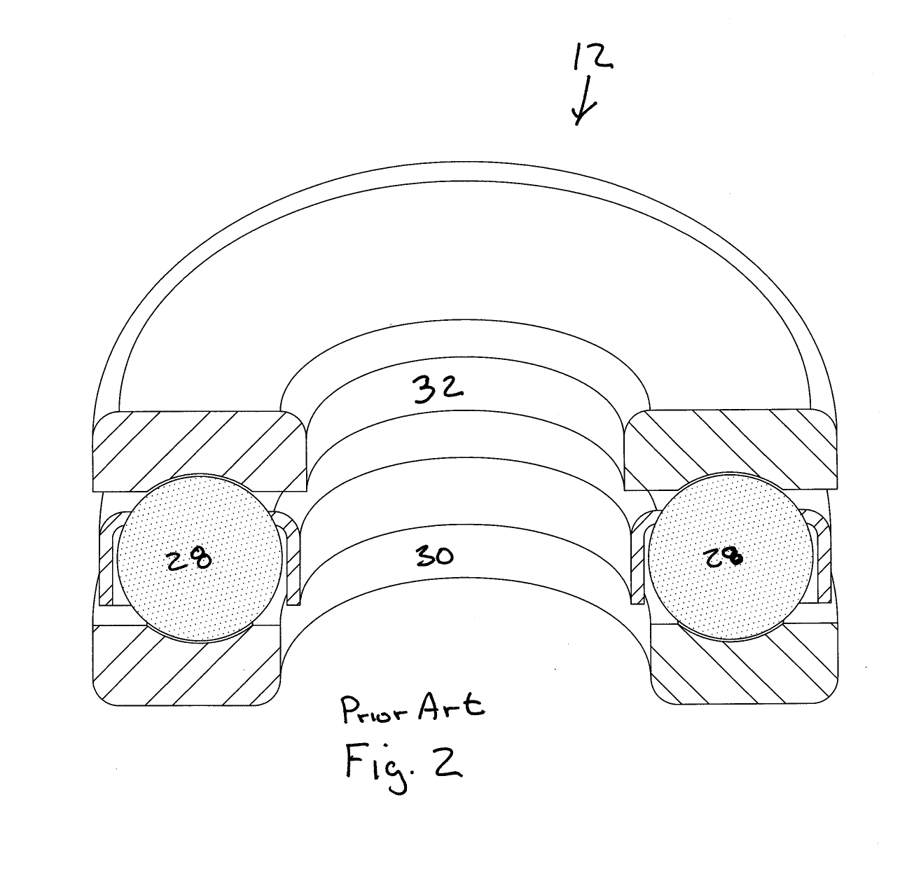

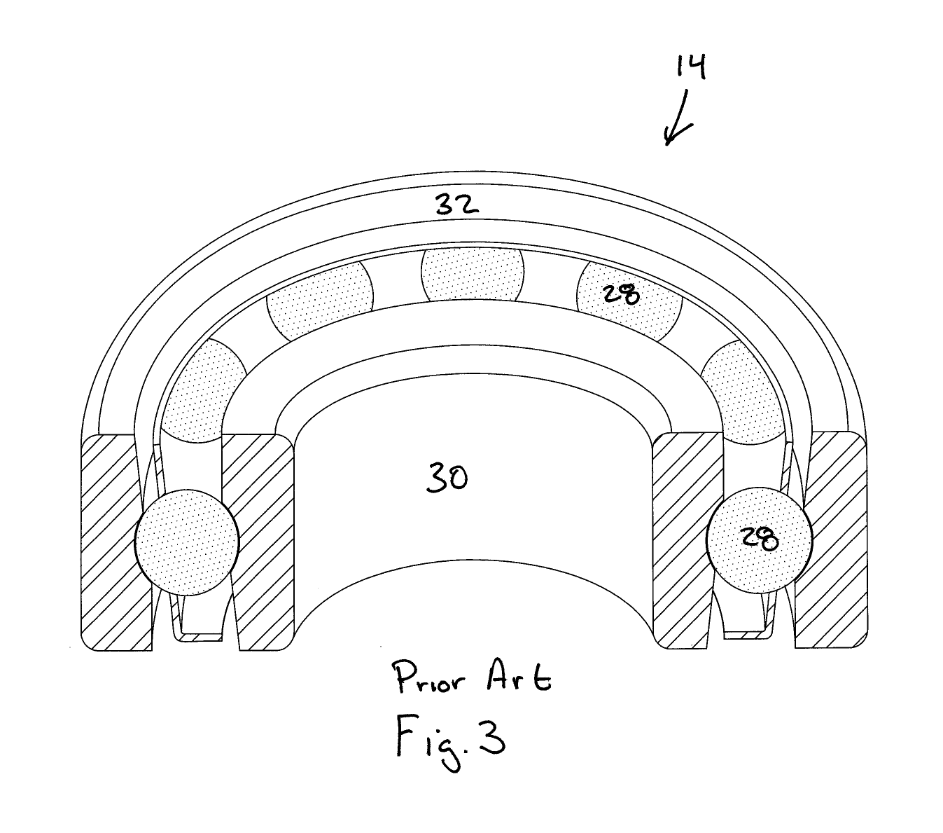

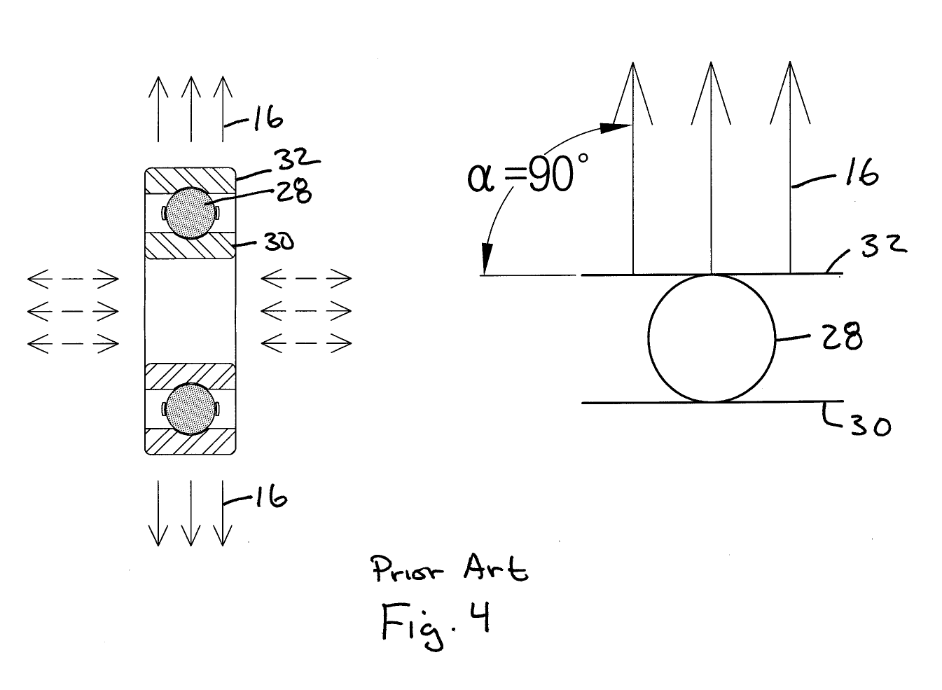

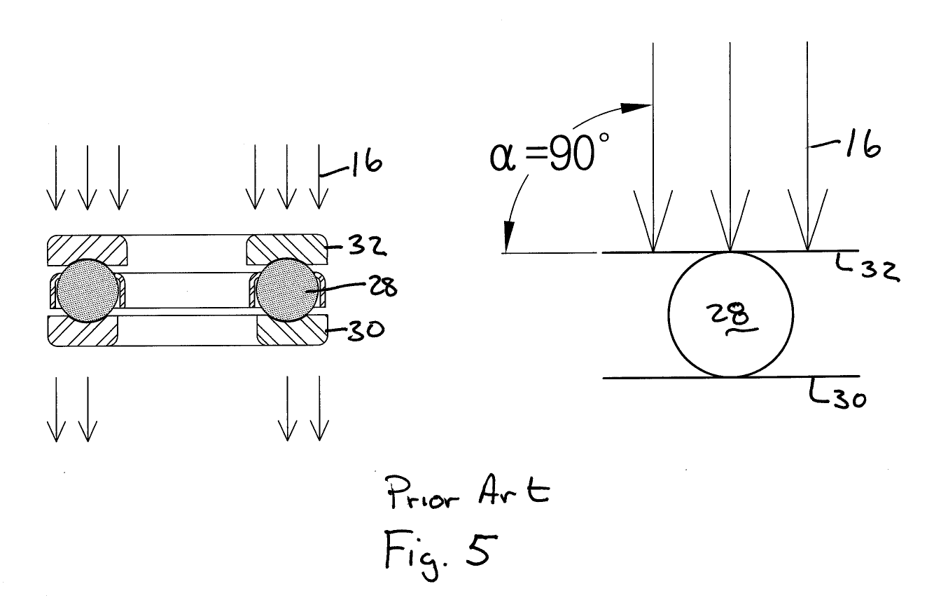

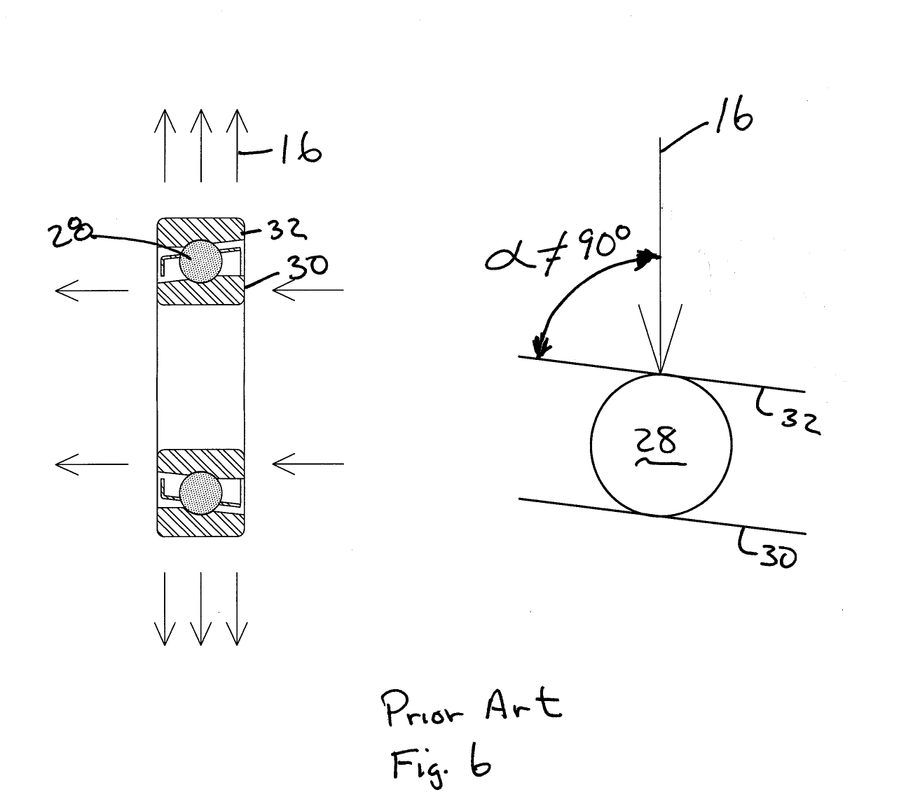

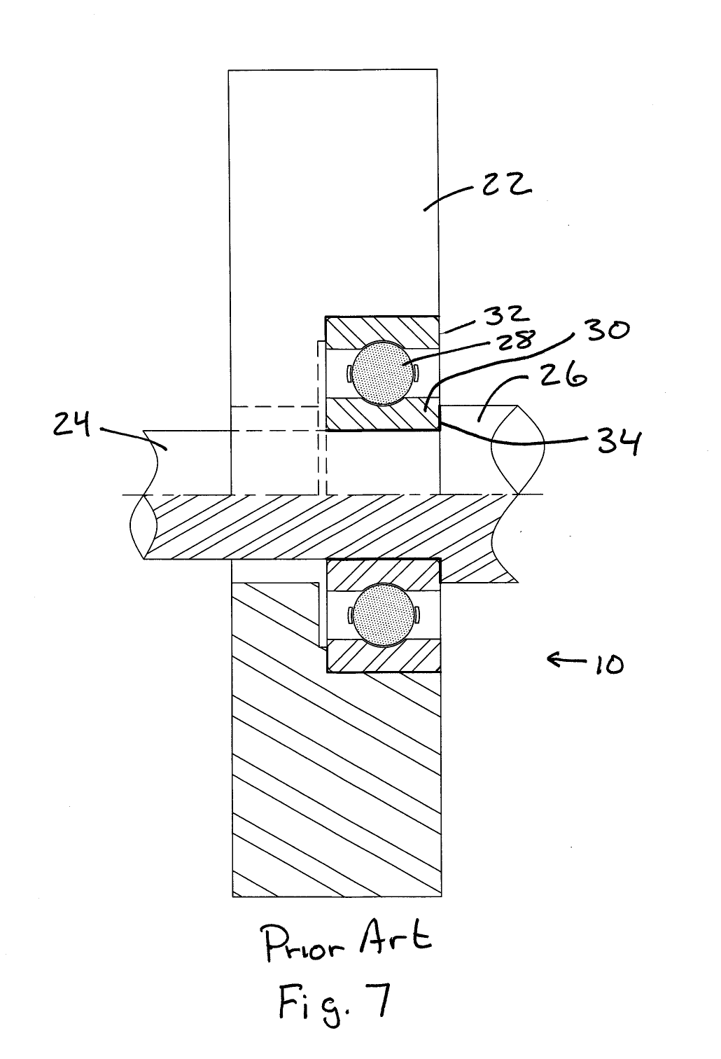

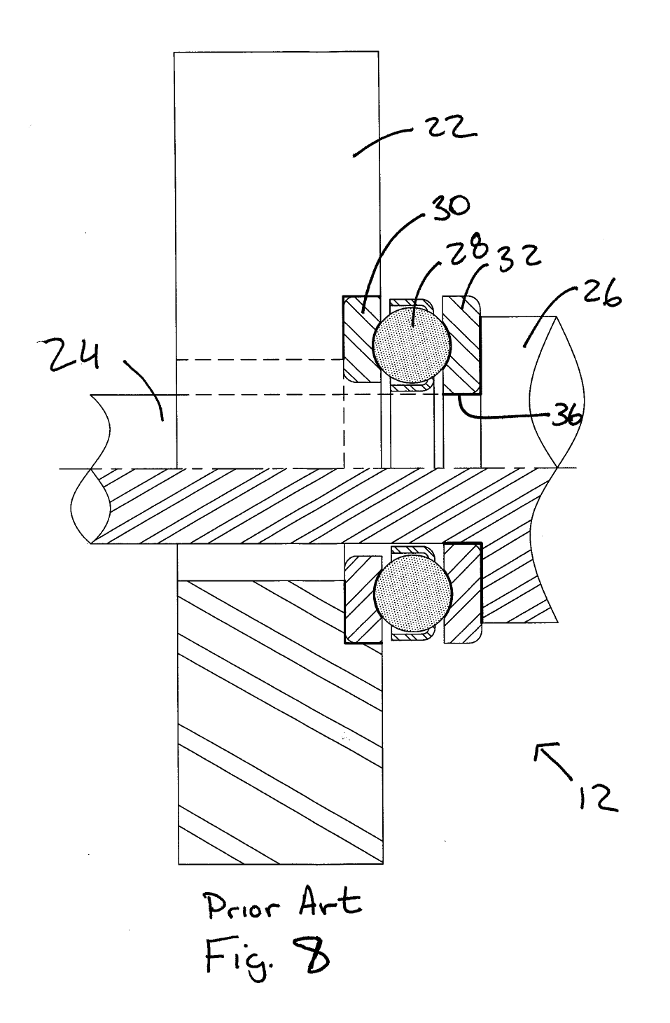

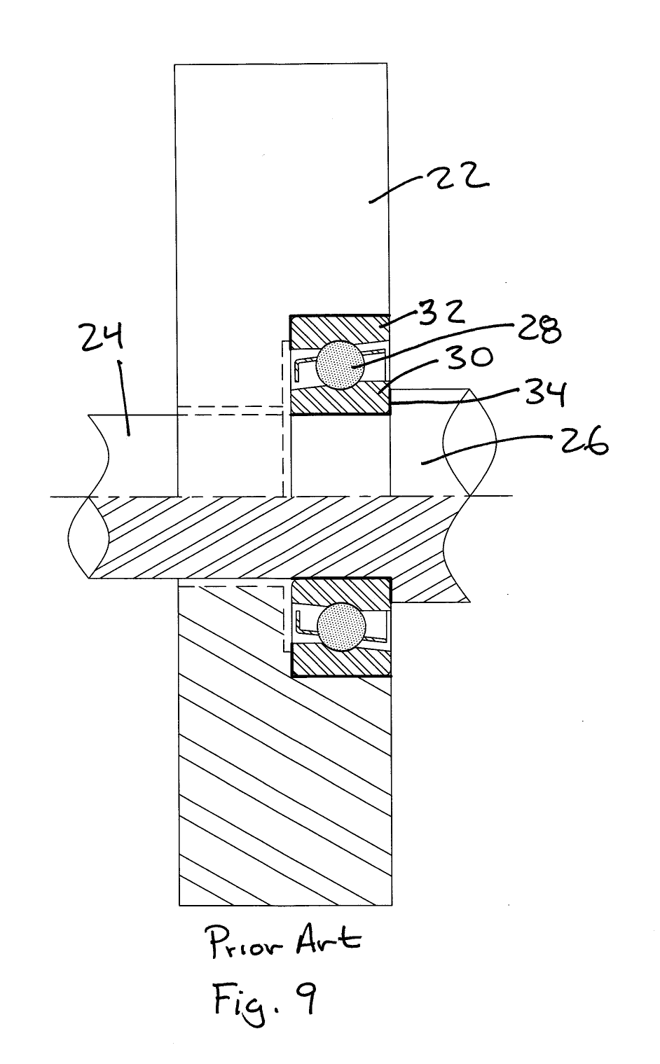

FIG. 1 shows a cross-sectional view of a prior art of a ball bearing assembly 10. FIG. 2 shows a cross-sectional view of a prior art thrust bearing assembly 12. FIG. 3 shows a cross-sectional view of a prior art angular bearing assembly 14. FIG. 4 shows the normal load 16 and angle α of the normal load 16 for the ball bearing assembly 10. FIG. 5 shows the normal load 16 and angle α of the normal load 16 for the thrust bearing assembly 12. FIG. 6 shows the normal load 16 and angle α of the normal load 16 for the angular bearing assembly 14. FIG. 7 shows the ball bearing assembly 10 mounted in a support frame 22 with shaft 24 and shoulder 26. FIG. 8 shows the thrust bearing assembly 12 mounted in a support frame 22 with shaft 24 and shoulder 26. FIG. 9 shows the angular bearing assembly 14 mounted in a support frame 22 with shaft 24 and shoulder 26. Each of the bearing assemblies 10, 12, 14 in FIGS. 1-9 are shown with balls 28, inner race frames 30 and outer race frames 32. FIGS. 1-9 are shown for references purposes to delineate the present invention over the prior art. As can be seen from FIGS. 7 and 9, the available contact surface area 34 of the inner race frame 30 with the shoulder 26 of the shaft 24 is minimal and does not extend the entire length between the OD and ID of the bearing assembly. As can be seen from FIG. 8, the available contact surface area 36 of the inner race frame 30 with the shaft 24 is minimal and does not extend the entire length between the inner race frame 30 and the outer race frame 32 of the bearing assembly.

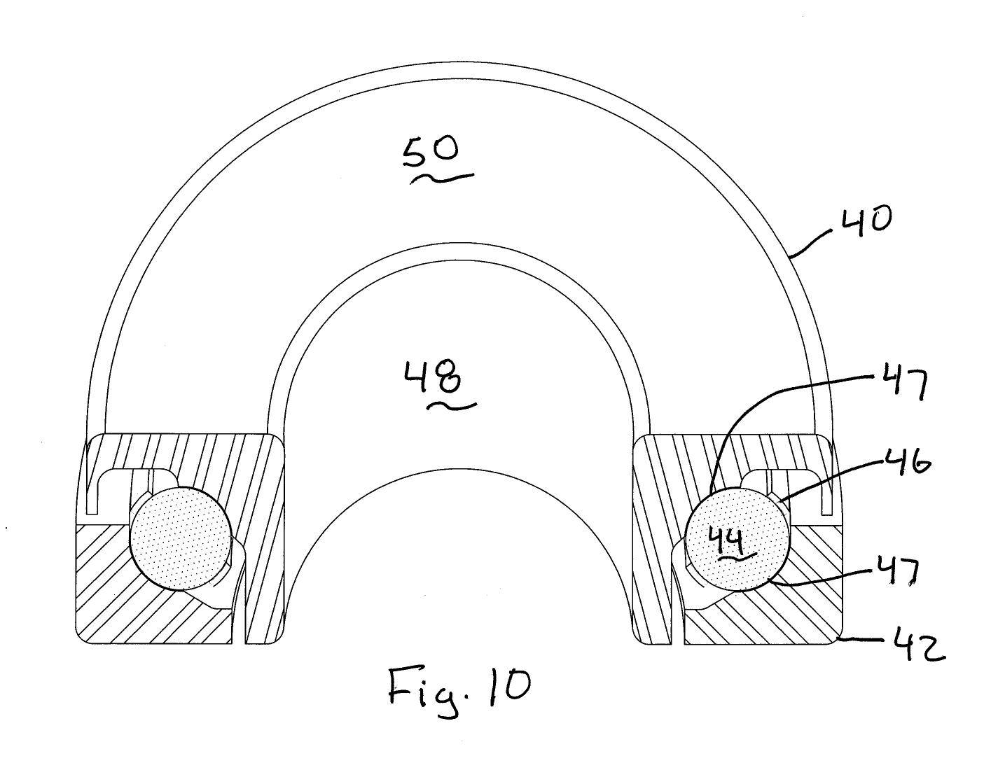

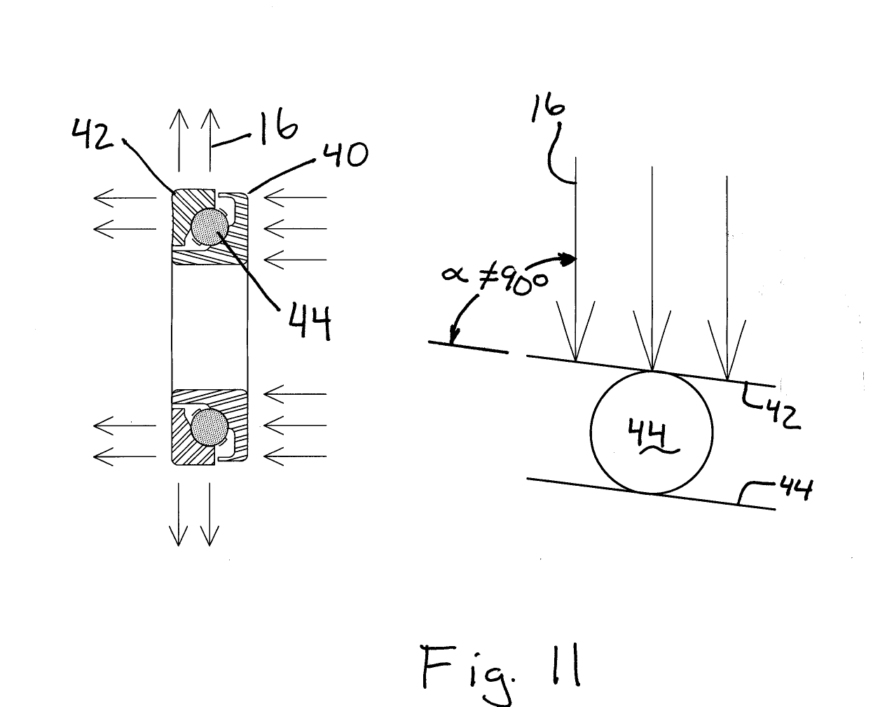

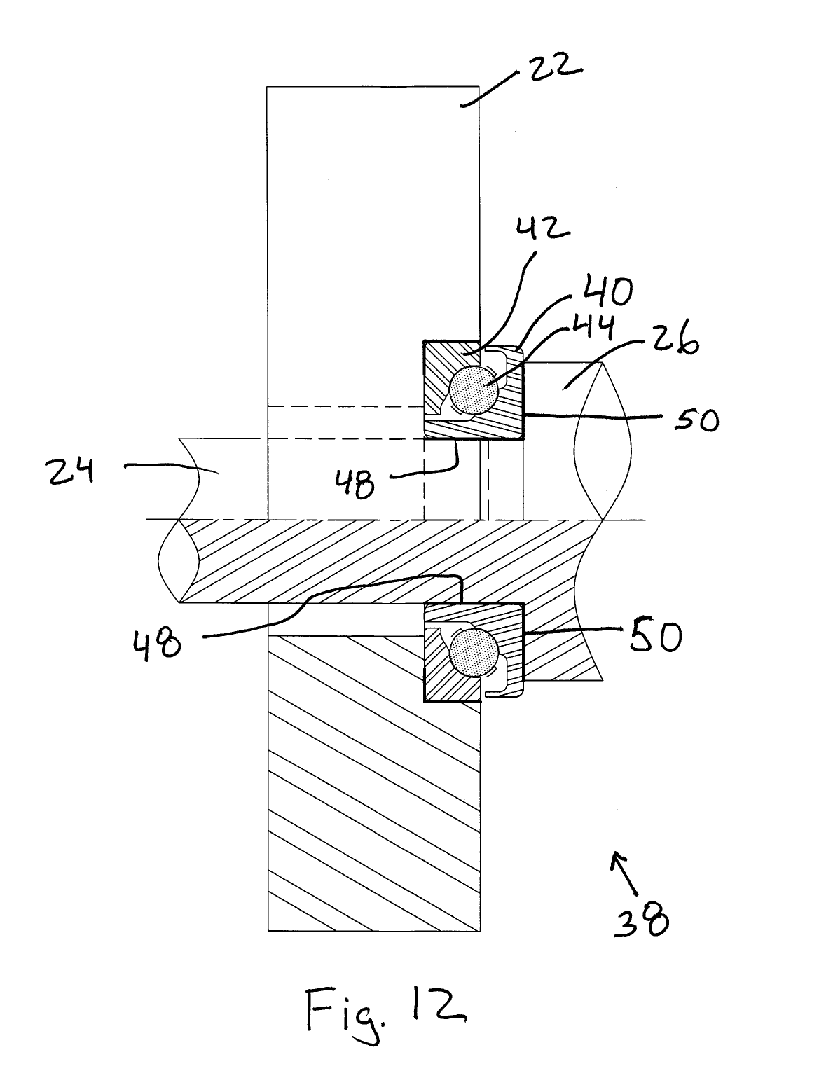

FIGS. 10-12 show schematic diagrams of a bearing assembly 38 according to the present invention. FIG. 10 shows a cross-sectional view of the bearing assembly 38, which includes the inner race frame 40, outer race frame 42, balls 44 and ball retainers 46. FIG. 11 shows the normal load 16 and angle α of the normal load 16 for the bearing assembly 38. FIG. 12 shows the bearing assembly 38 mounted in a support frame 22 with shaft 24 and shoulder 26. As can be seen from FIGS. 4 and 5, the angle a of the normal load 16 is ninety (90) degrees. As can be seen from FIG. 6, the angle α of the normal load 16 is less than ninety (90) degrees. Typically, when the angle α of the normal load 16 is less than ninety (90) degrees, it is no less than sixty (60) degrees. The bearing assembly 38 in FIG. 11 has an angle α of the normal load that is between forty (40) and fifty (50) degrees. Having an angle α between forty (40) and fifty (50) degrees improves the distribution of the normal load stress caused by the normal load 16 over a wider angle and area of contact. As shown in FIGS. 10-12 both races 47 of the inner race frame 40 and outer race frame 42 are much wider and covering more ball 44 as compared to those of FIGS. 1-9, due to the angle α being between forty (40) and fifty (50) degrees.

As shown in FIG. 12, the inner race frame 40 of bearing assembly 38 provides more contact area with the shaft 24 and shoulder 26 than currently provided by the prior art shown in FIGS. 1-9. The inner race frame 40 has a shaft surface contact area 48 which at least ninety-five (95) percent of the width of the bearing assembly 38 about the shaft 24. The inner race frame 40 has a shoulder surface contact area 50 which is at least ninety-five (95) percent of the thickness area of the bearing assembly 38. Whereby, the thickness area of the bearing assembly 38 is the area between the OD of the bearing assembly 38 and the ID value of the bearing assembly 38. Having a shoulder surface contact area 50 which is at least ninety-five (95) percent of the thickness area of the bearing assembly 38 improves the stability of the bearing assembly 38.

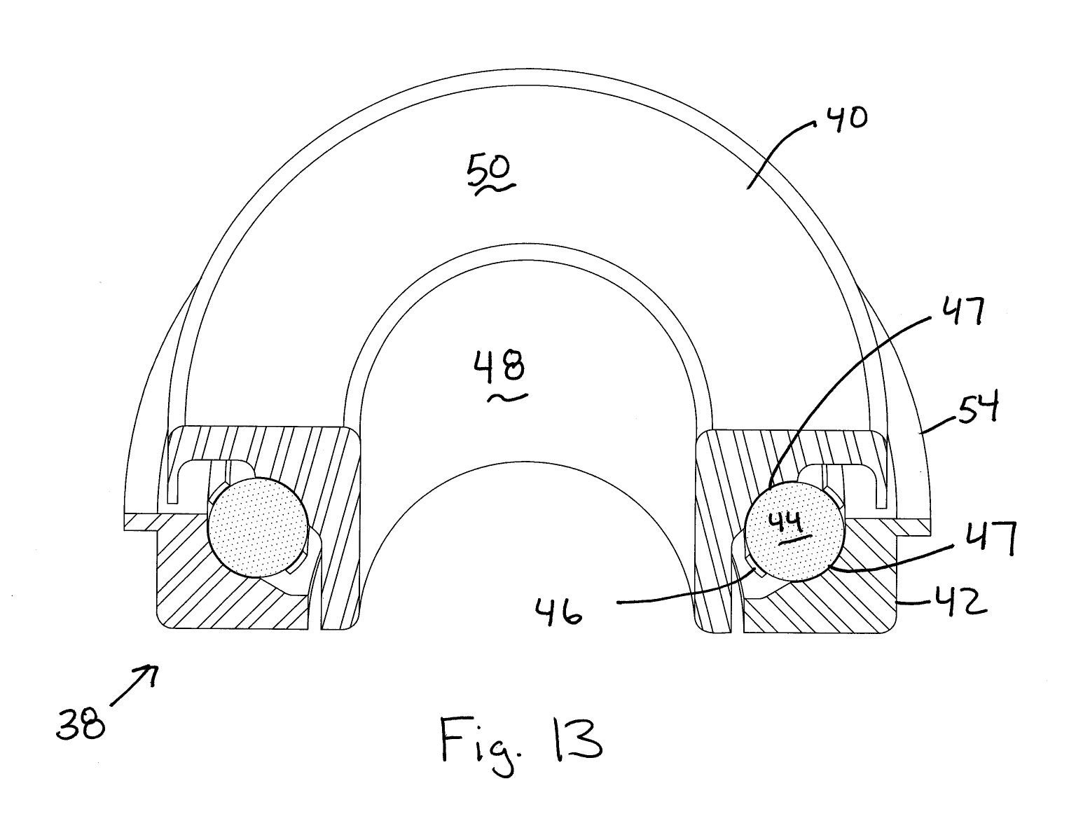

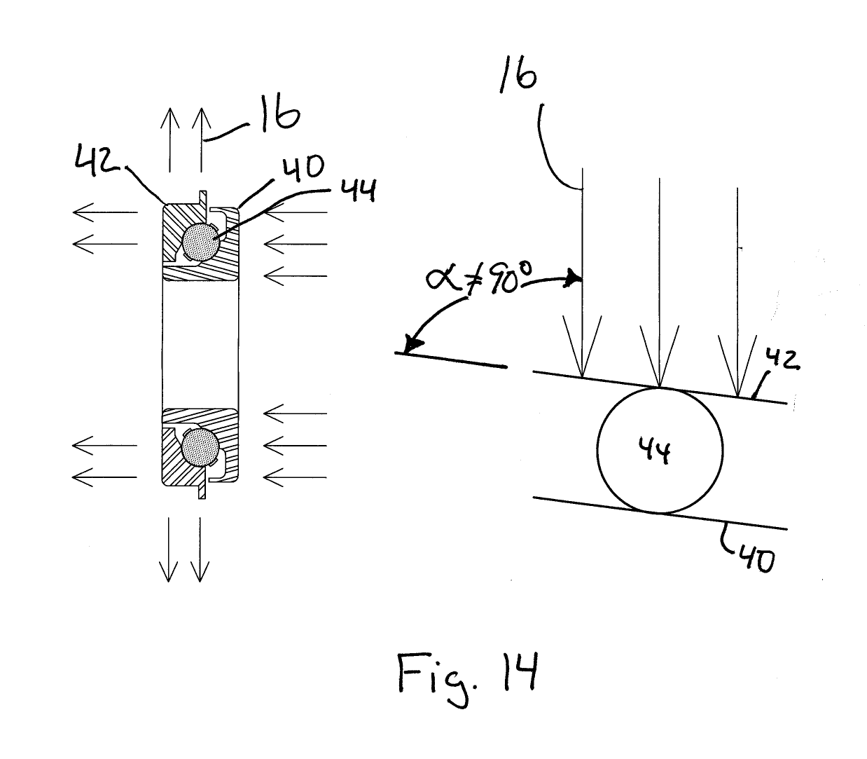

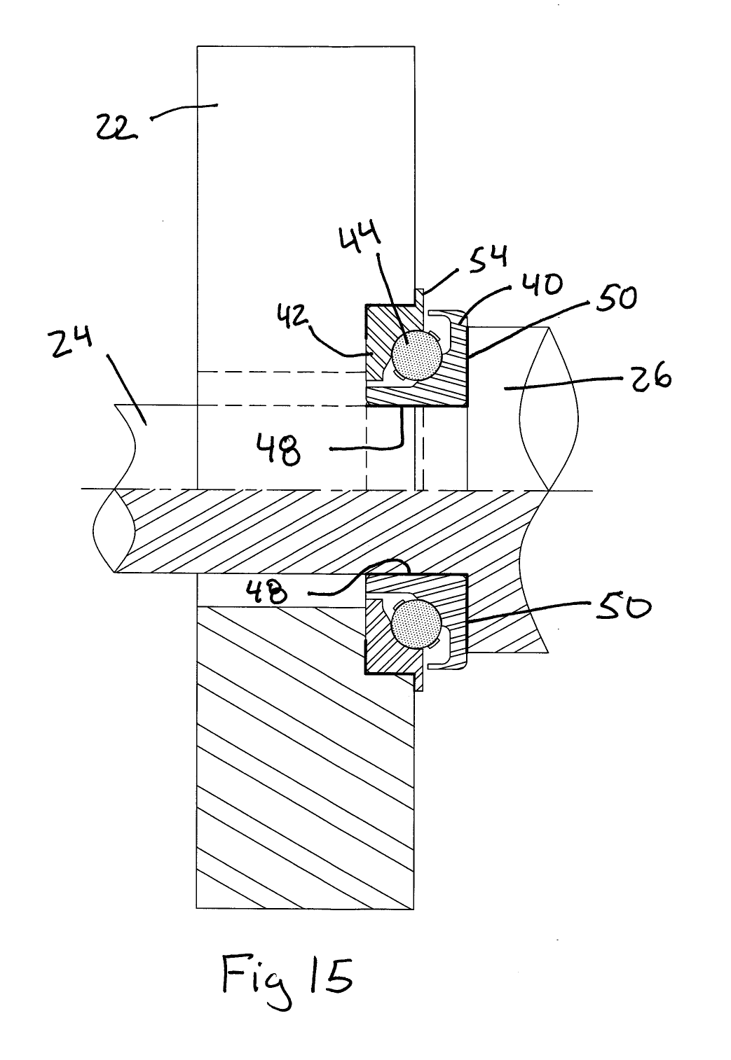

FIGS. 13-15 show schematic diagrams of a bearing assembly 38 of FIGS. 10-12 with a flange 54 as part of the outer race frame 42. FIG. 13 shows a cross-sectional view of the bearing assembly 38, which includes the inner race frame 40, outer race frame 42, balls 44 and ball retainers 46. FIG. 14 shows the normal load 16 and angle α of the normal load 16 for the bearing assembly 38. FIG. 15 shows the bearing assembly 38 mounted in a support frame 22 with shaft 24 and shoulder 26. The flange 54 of the outer race frame 42 improves the stability of the bearing assembly 38, by having an additional surface attached to the support frame 22.

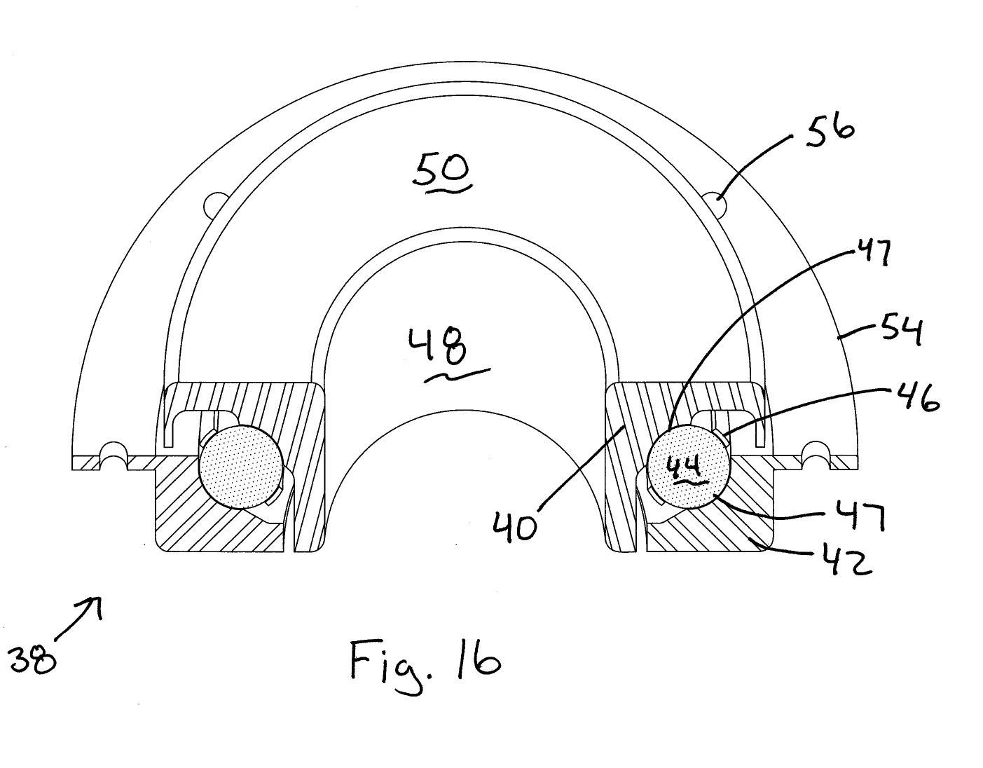

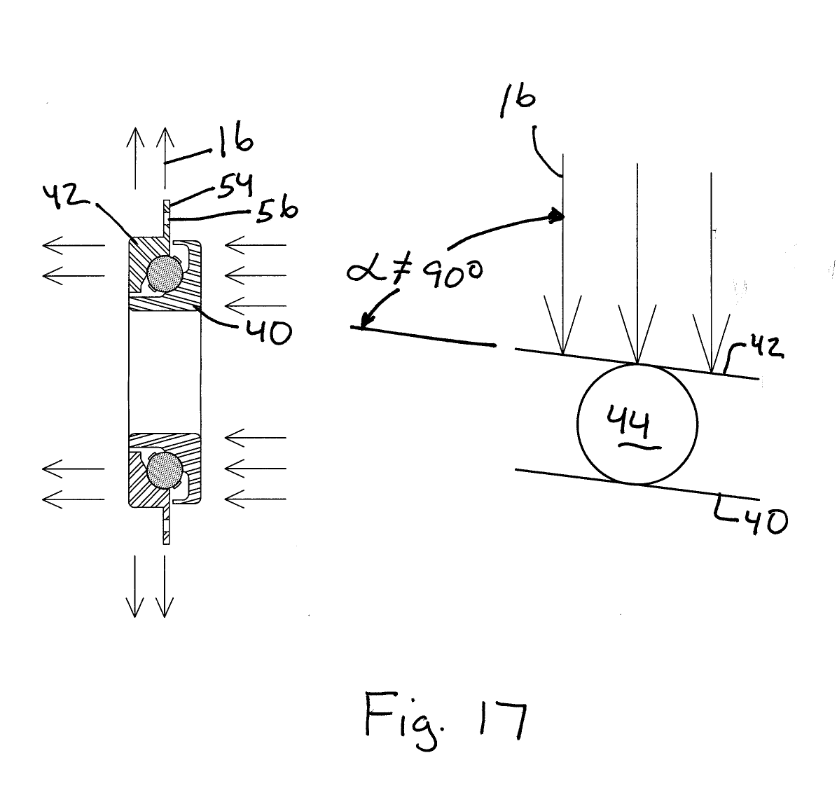

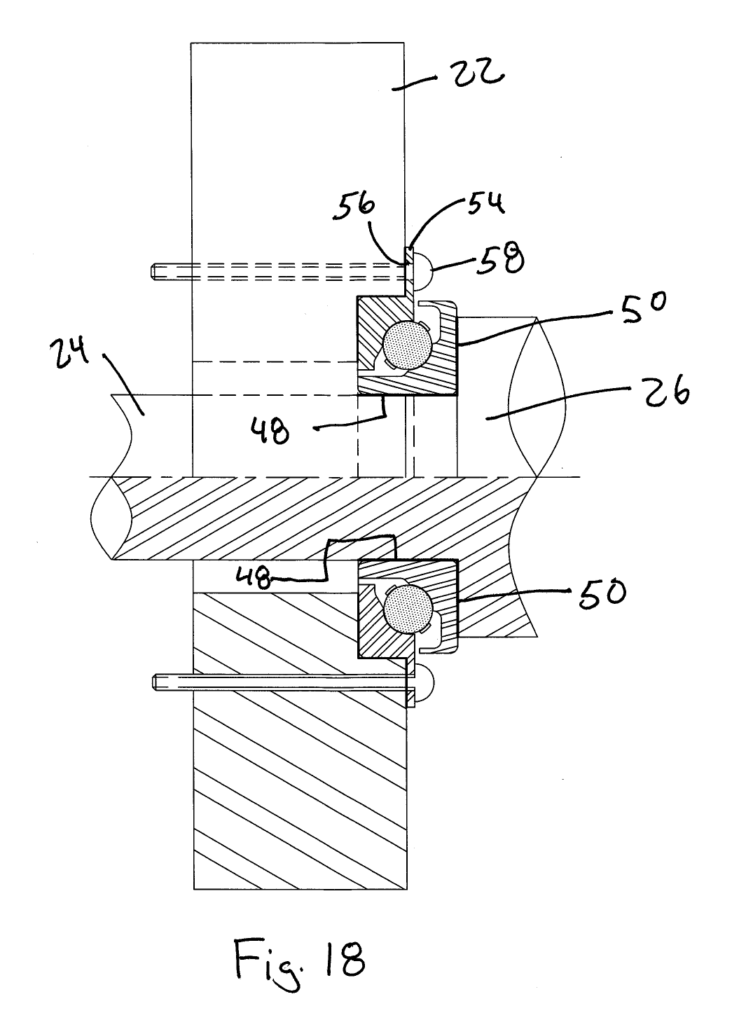

FIGS. 16-18 show schematic diagrams of a bearing assembly 38 of FIGS. 13-15 with bolt holes 56 in the flange 54 as part of the outer race frame 42. FIG. 16 shows a cross-sectional view of the bearing assembly 38, which includes the inner race frame 40, outer race frame 42, balls 44 and ball retainers 46. FIG. 17 shows the normal load 16 and angle α of the normal load 16 for the bearing assembly 38. FIG. 18 shows the bearing assembly 38 mounted in a support frame 22 with shaft 24 and shoulder 26. FIG. 18 also shows bolts 58 inserted into the bolt holes 56 of the flange 54 and connected to the support frame 22. The flange 54 of the outer race frame 38 with bolts holes 56 improves the stability of the bearing assembly 35, by allowing the outer race frame 42 to be secured to the support frame 22 with bolts 58.

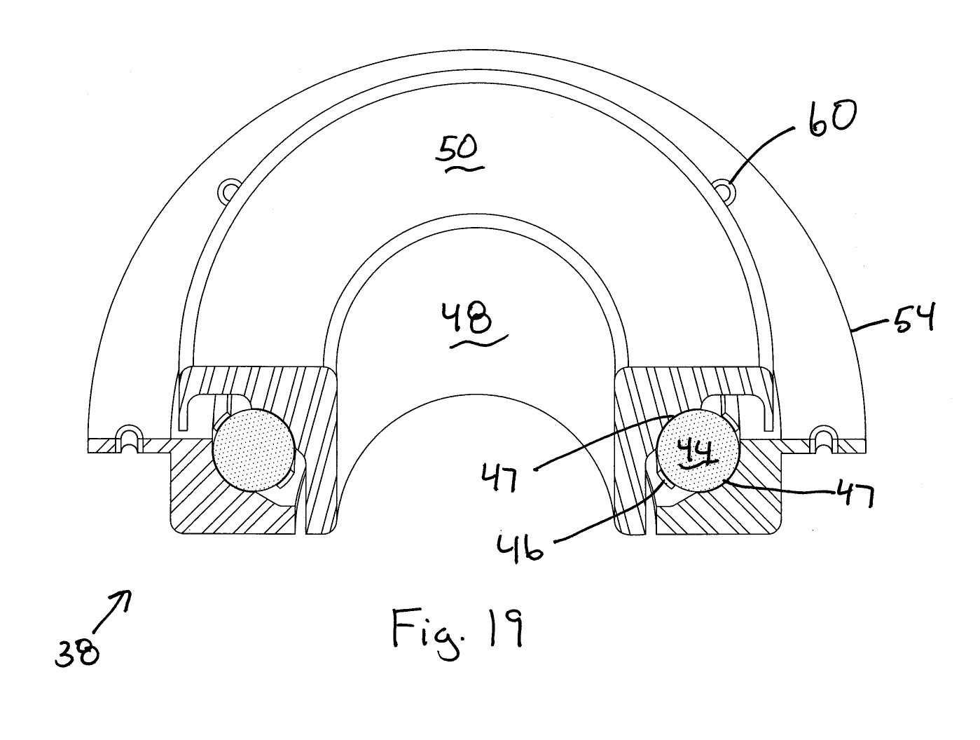

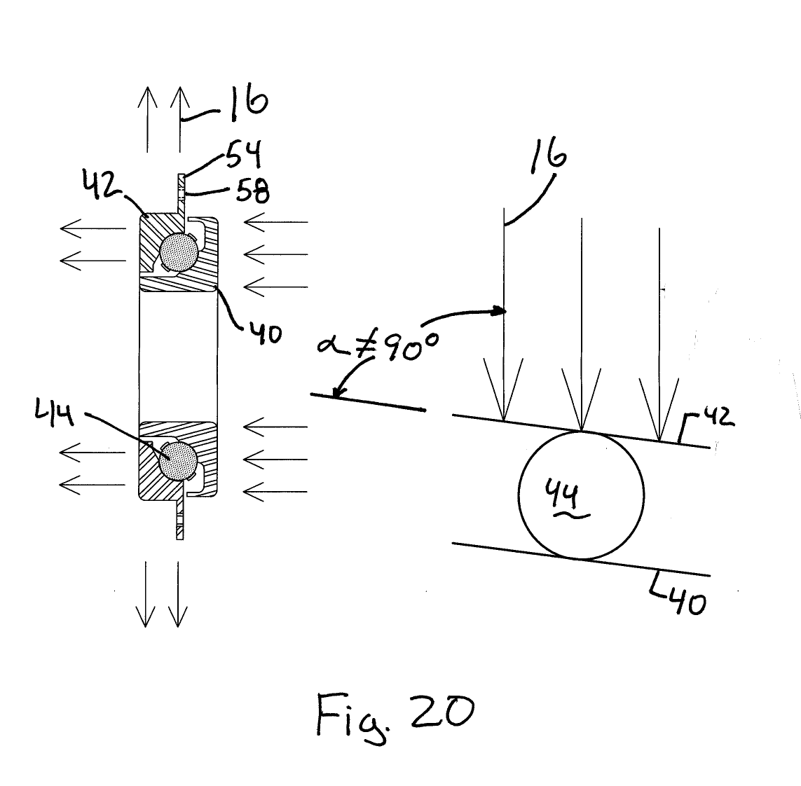

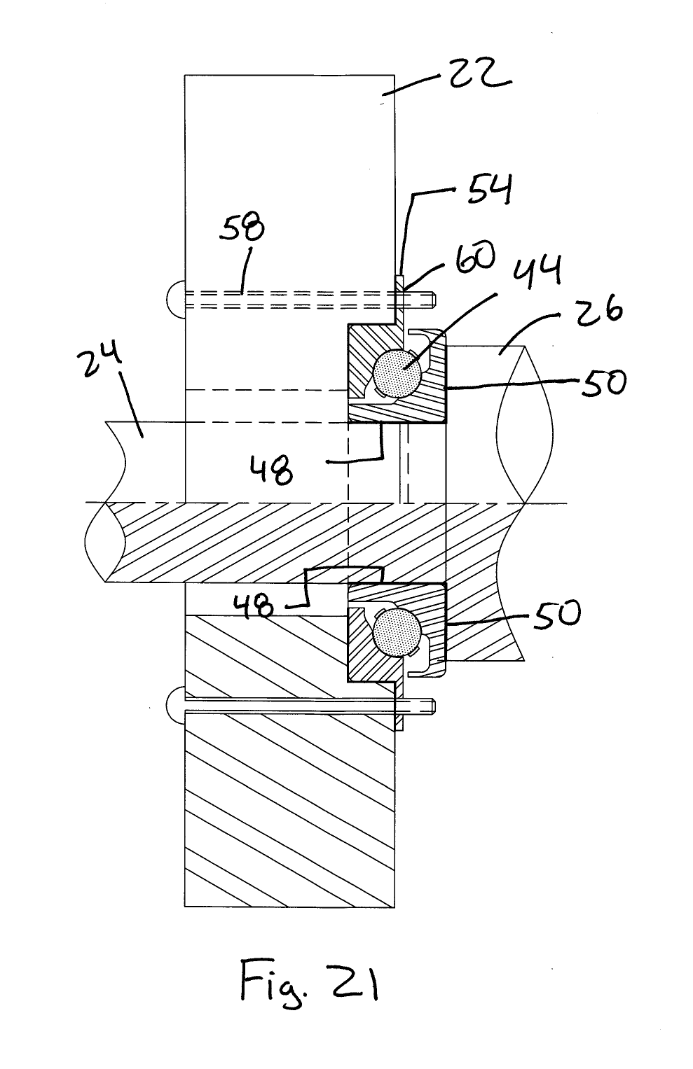

FIGS. 19-21 show schematic diagrams of a bearing assembly 38 of FIGS. 13-15 with threaded holes 60 in the flange 54 as part of the outer race frame 42. FIG. 19 shows a cross-sectional view of the bearing assembly 38, which includes the inner race frame 40, outer race frame 42, balls 44 and ball retainers 46. FIG. 20 shows the normal load 16 and angle α of the normal load 16 for the bearing assembly 38. FIG. 21 shows the bearing assembly 38 mounted in a support frame 22 with shaft 24 and shoulder 26. FIG. 21 also shows bolts 58 inserted into the support frame 22 and the bolts 58 fastened to the threaded holes 60 of the flange 54. The flange 54 of the outer race frame 38 with threaded holes 60 improves the stability of the bearing assembly 38, by allowing the outer race frame 42 to be secured to the support frame 22 with bolts 58.

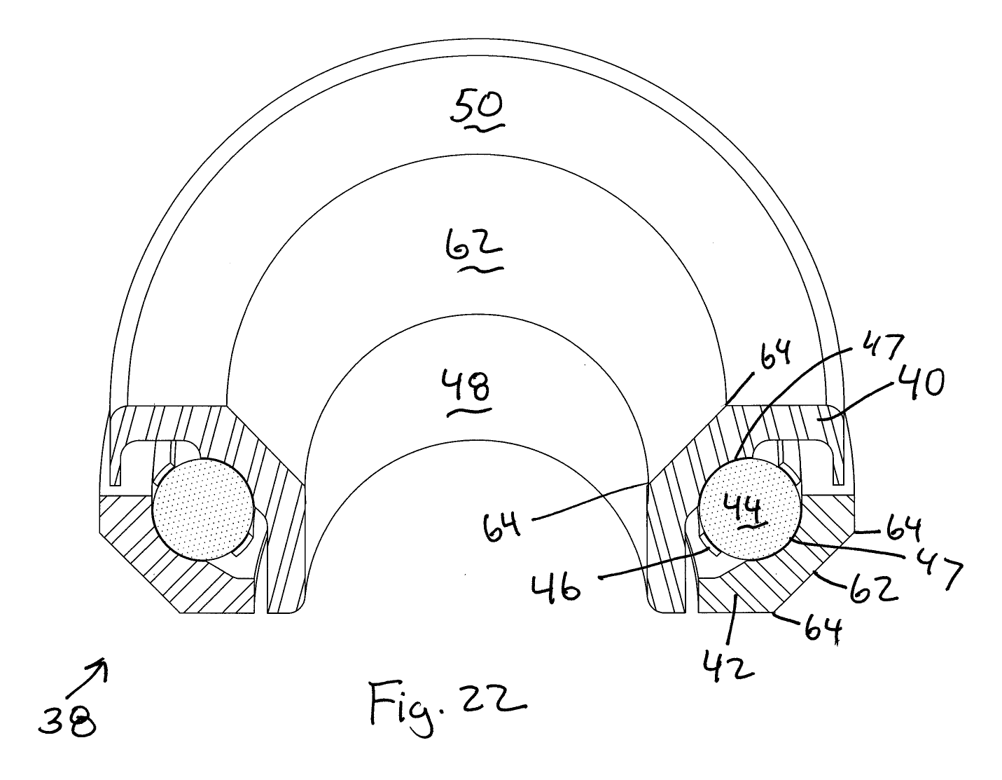

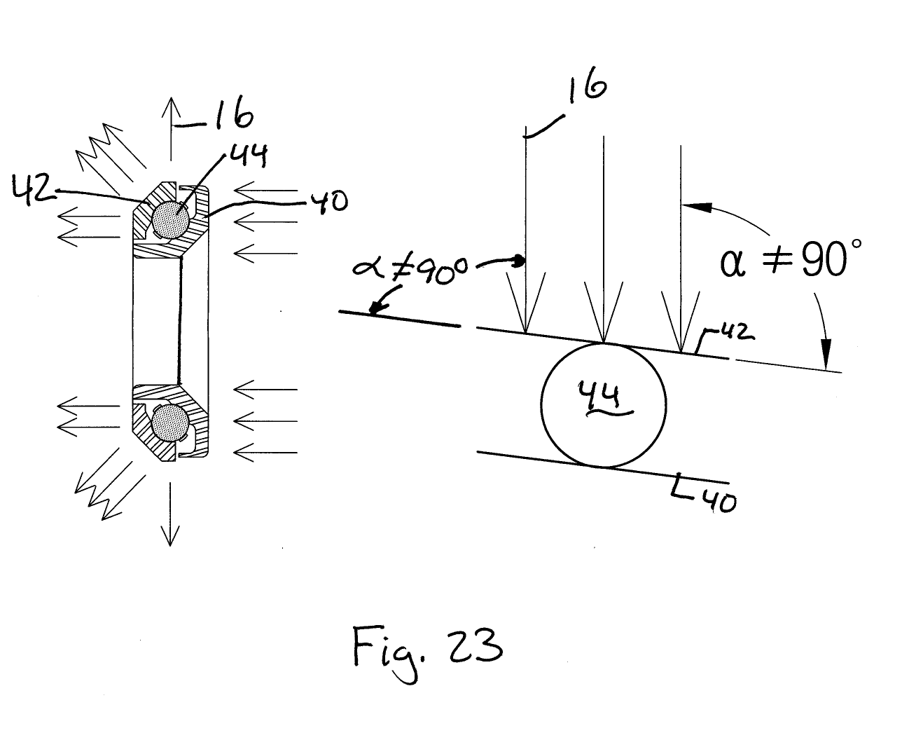

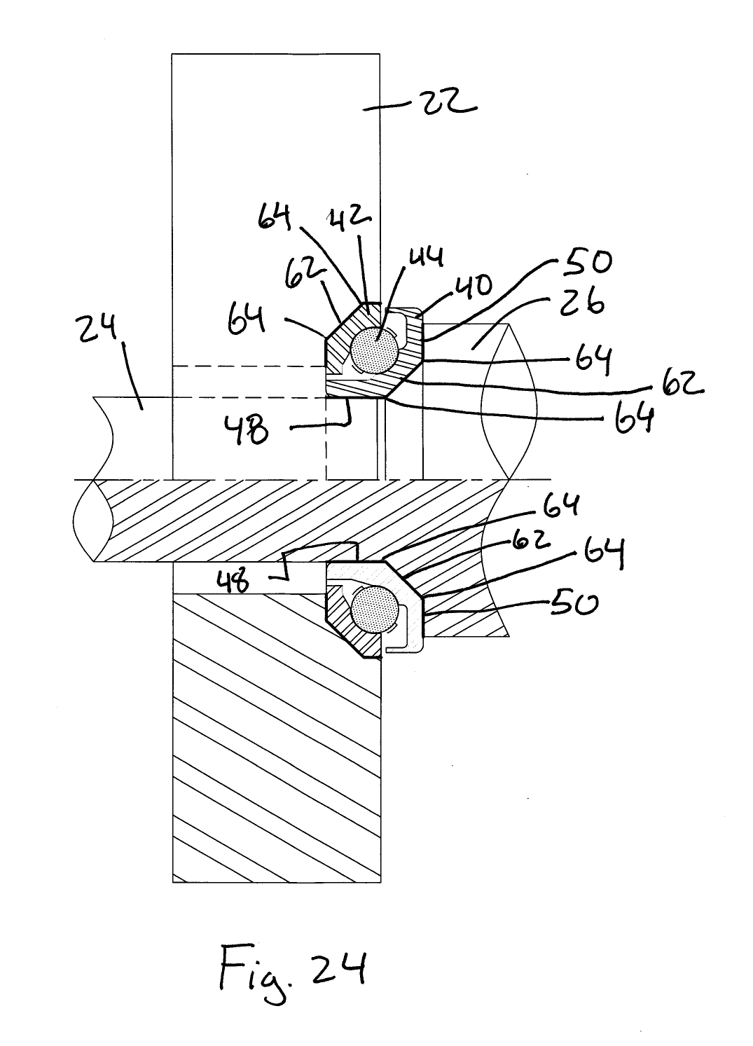

FIGS. 22-24 show schematic diagrams of a bearing assembly 38 of FIGS. 10-12 with an angled surface 62 on each of the race frames 40, 42. FIG. 22 shows a cross-sectional view of the bearing assembly 38, which includes the inner race frame 40, outer race frame 42, balls 44 and ball retainers 46. FIG. 23 shows the normal load 16 and angle α of the normal load 16 for the bearing assembly 38. FIG. 24 shows the bearing assembly 38 mounted in a support frame 22 with shaft 24 and shoulder 26. The angled surface 62 on both of race frames 40, 42 creates two corners 64 instead of just one corner 66 as shown in FIGS. 10-12. This is an improvement for the contact surface of outer race frame 42 with the support frame 22. The two corners 64 on each of the race frames 40, 42 improves the stability of the bearing assembly 38 by providing two points which pin the race frames 40, 42 to the support frame 22 and areas of the shaft 24 and shoulder 26 area.

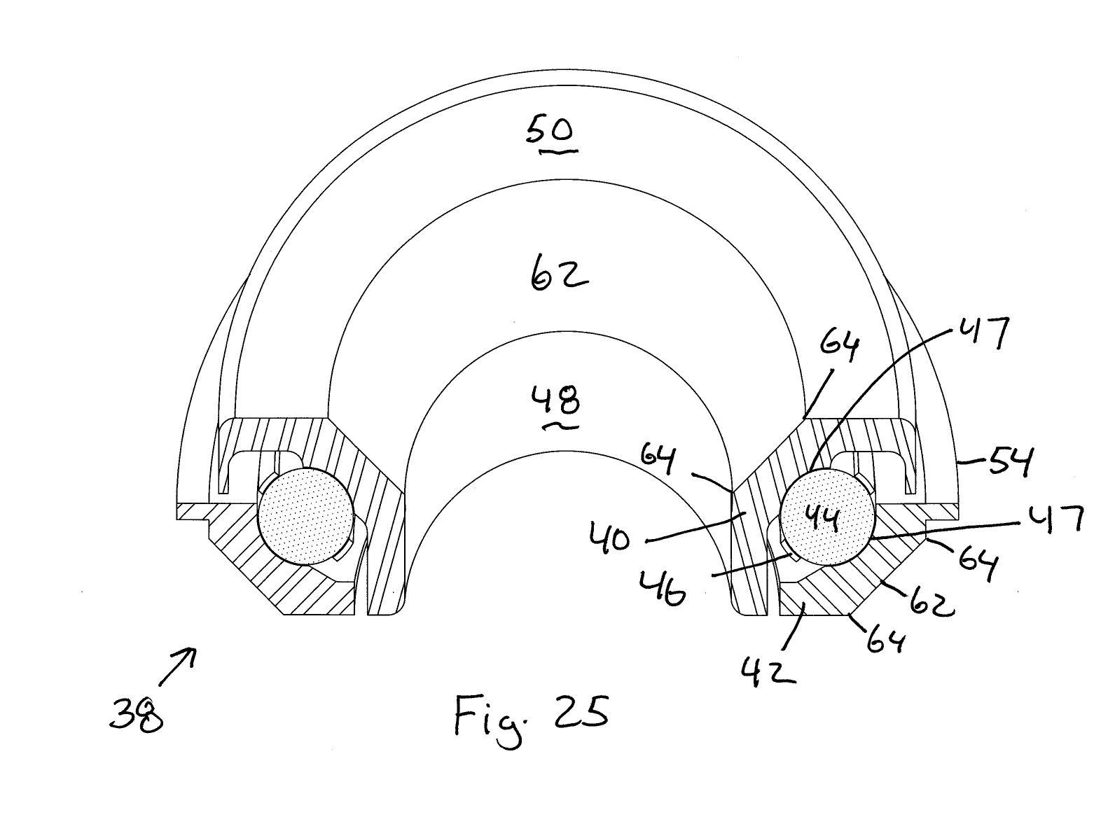

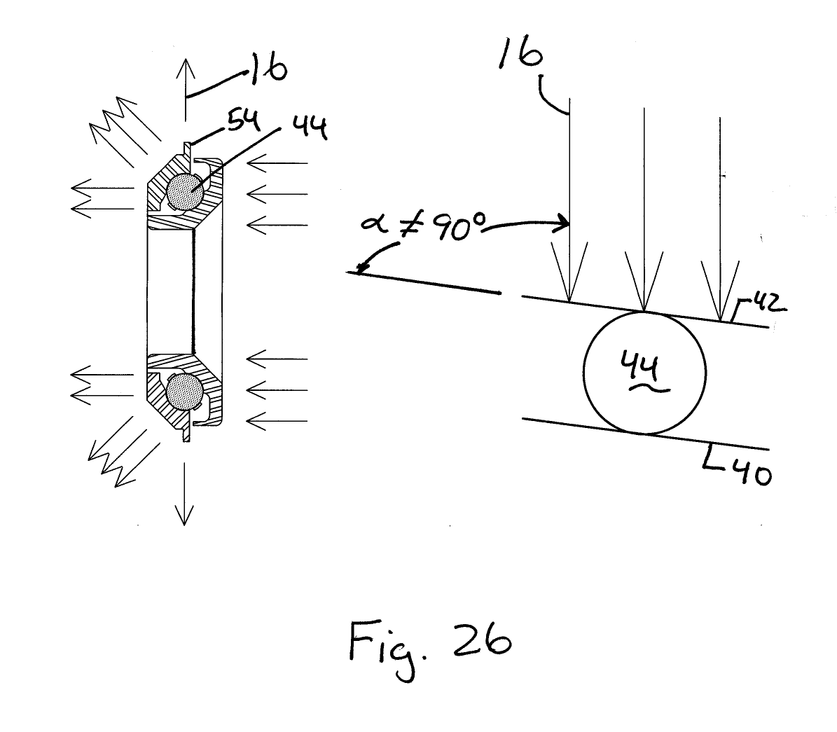

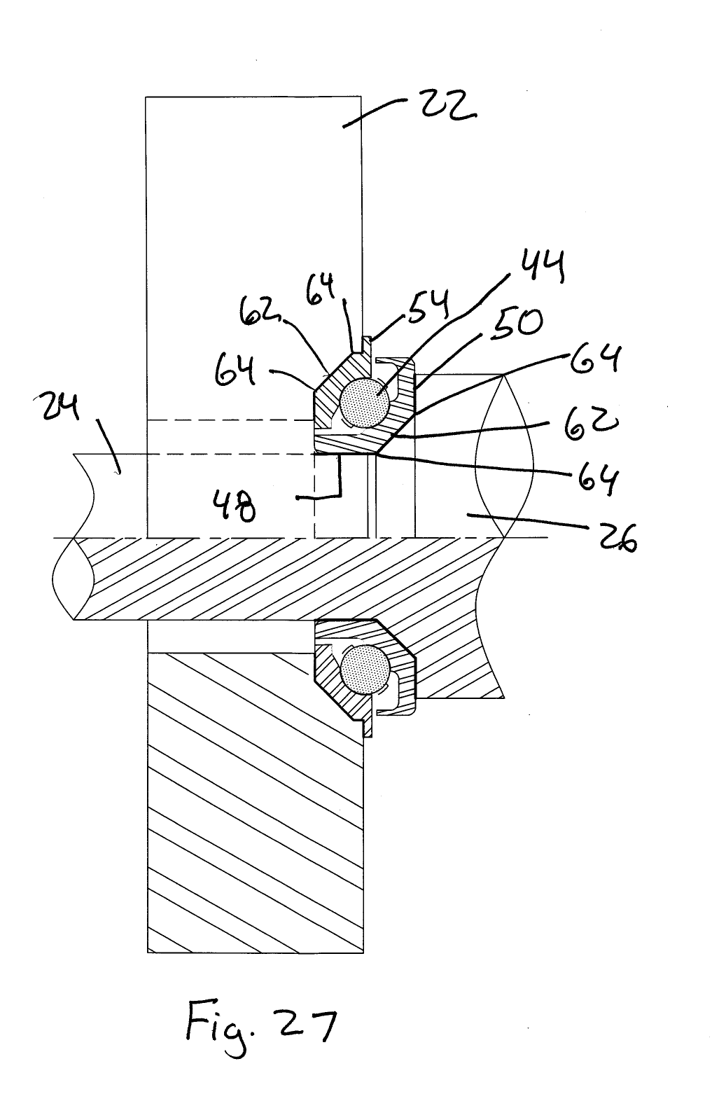

FIGS. 25-27 show schematic diagrams of a bearing assembly 38 of FIGS. 22-24 with a flange 64 as part of the outer race frame 42. FIG. 25 shows a cross-sectional view of the bearing assembly 38, which includes the inner race frame 40, outer race frame 42, balls 44 and ball retainers 46. FIG. 26 shows the normal load 16 and angle α of the normal load 16 for the bearing assembly 38. FIG. 27 shows the bearing assembly 38 mounted in a support frame 22 with shaft 24 and shoulder 26. The flange 54 of the outer race frame 42 improves the stability of the bearing assembly 38, by having an additional surface attached to the support frame 22.

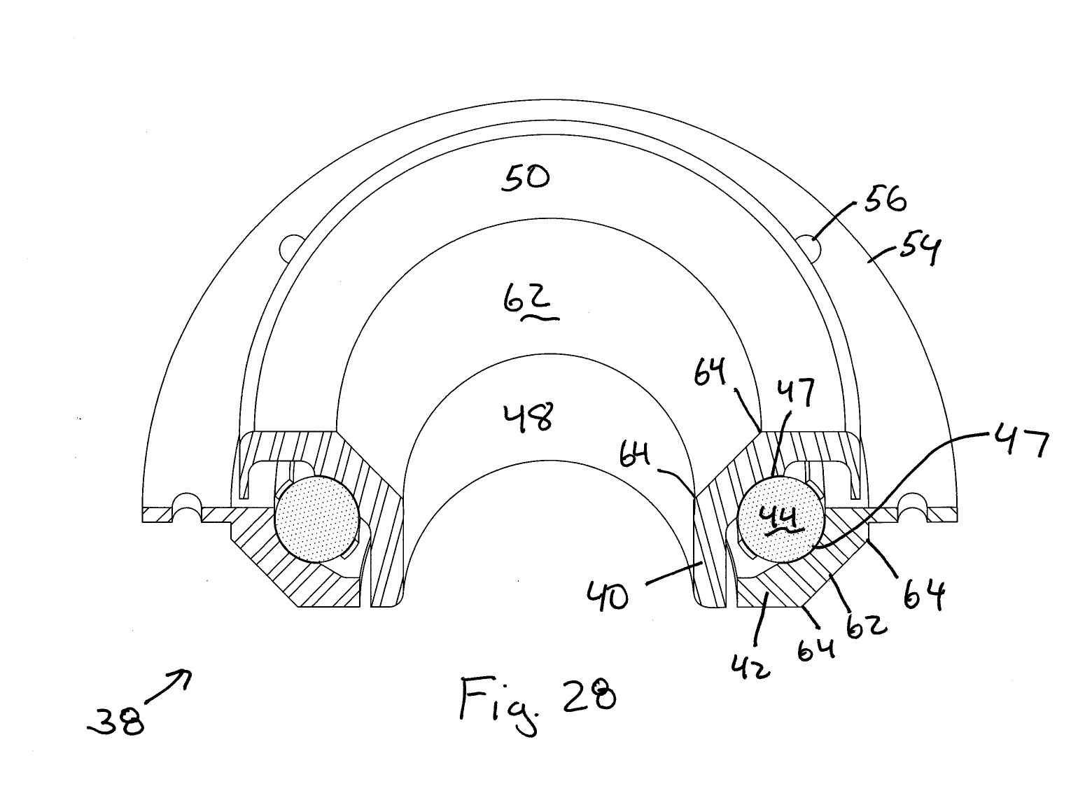

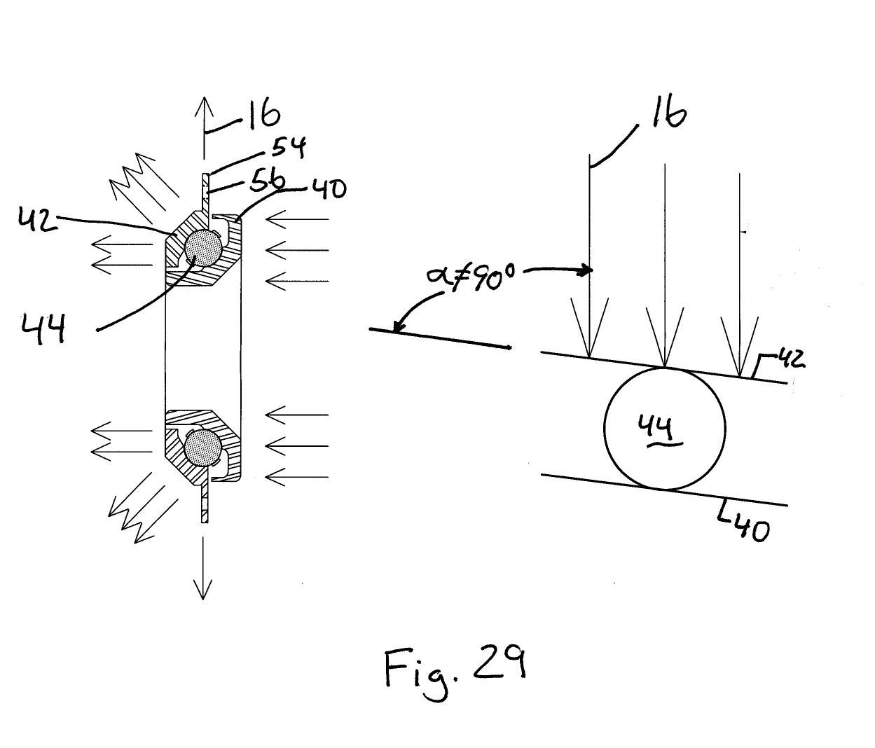

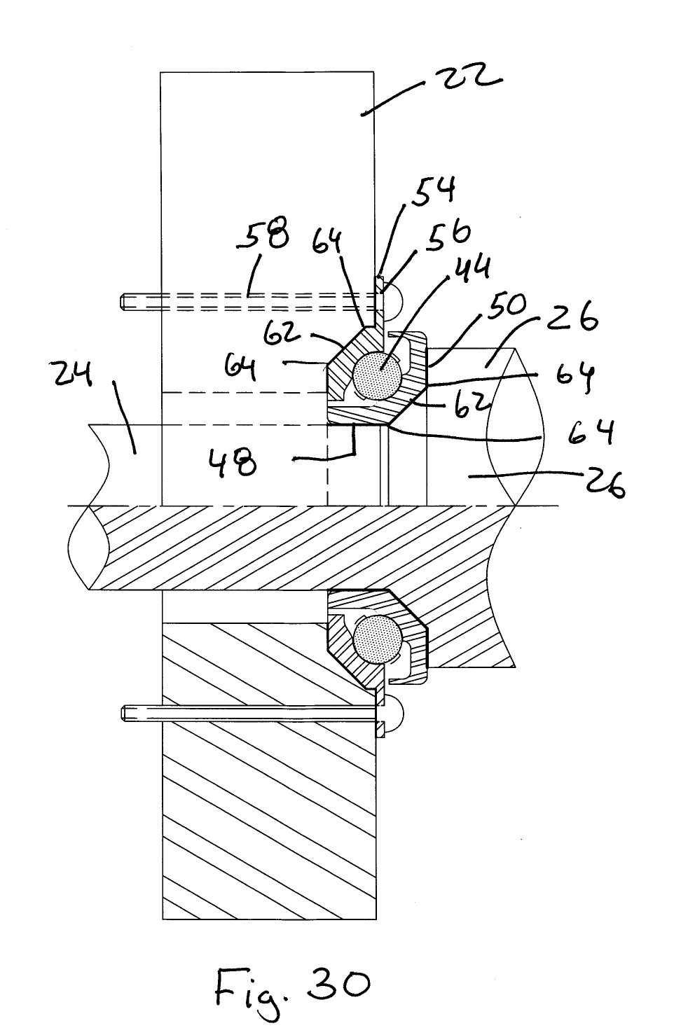

FIGS. 28-30 show schematic diagrams of a bearing assembly 38 of FIGS. 25-27 with bolt holes 56 in the flange 54 as part of the outer race frame 42. FIG. 28 shows a cross-sectional view of the bearing assembly 38, which includes the inner race frame 40, outer race frame 42, balls 44 and ball retainers 46. FIG. 29 shows the normal load 16 and angle α of the normal load 16 for the bearing assembly 38. FIG. 30 shows the bearing assembly 38 mounted in a support frame 22 with shaft 24 and shoulder 26. FIG. 30 also shows bolts 58 inserted into the bolt holes 56 of the flange 54 and connected to the support frame 22. The flange 54 of the outer race frame 42 with bolt holes 56 improves the stability of the bearing assembly 38, by allowing the outer race frame 42 to be secured to the support frame 22 with bolts 56.

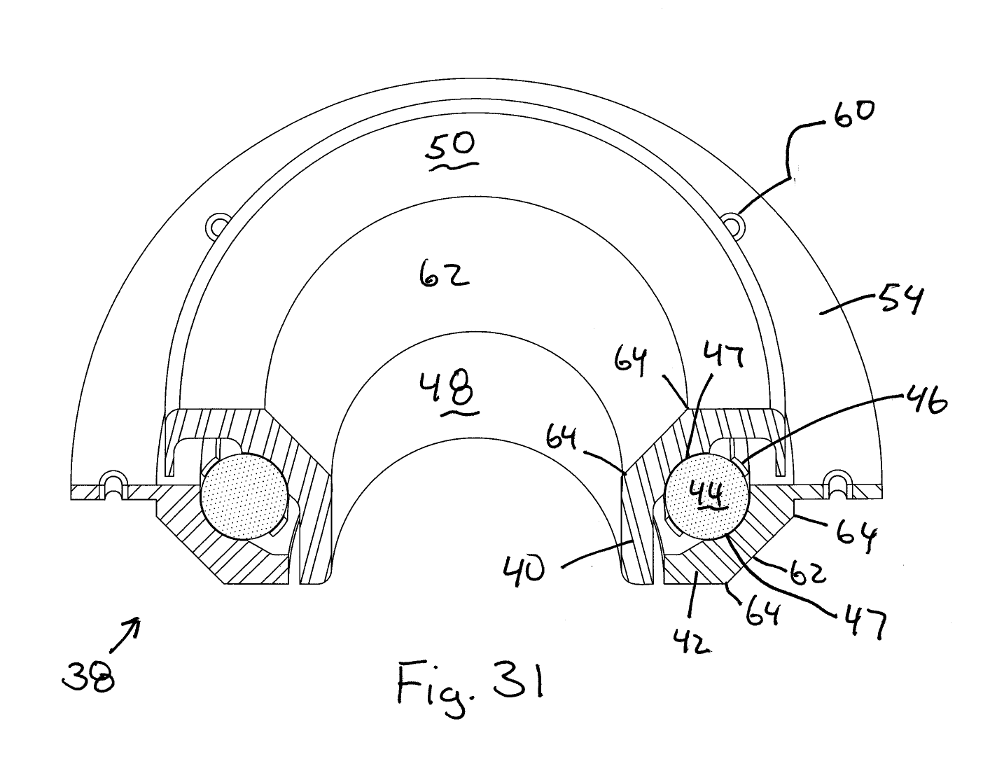

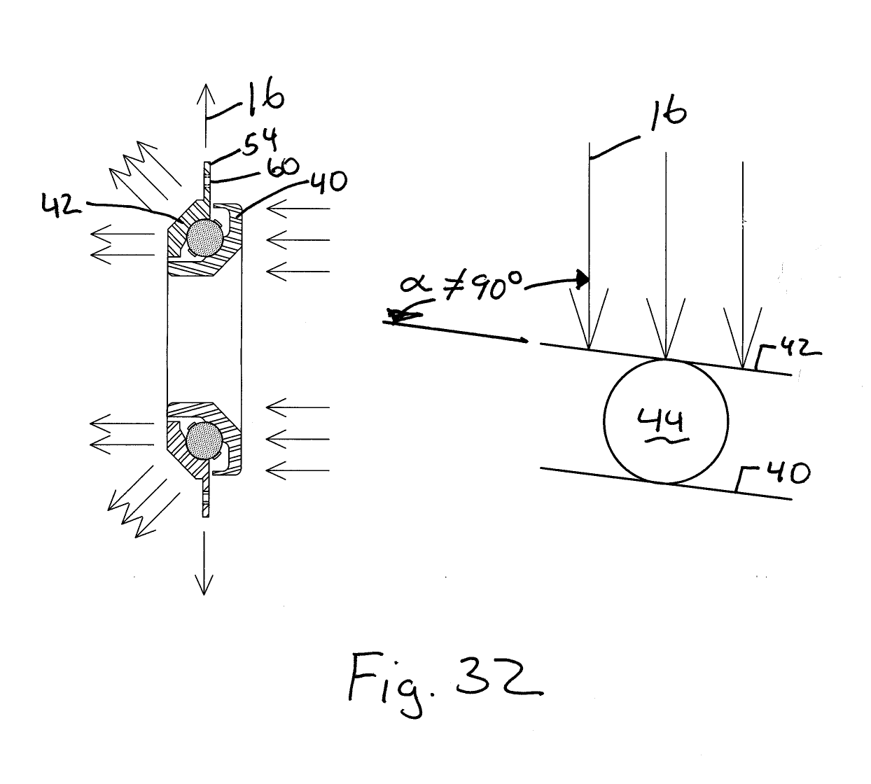

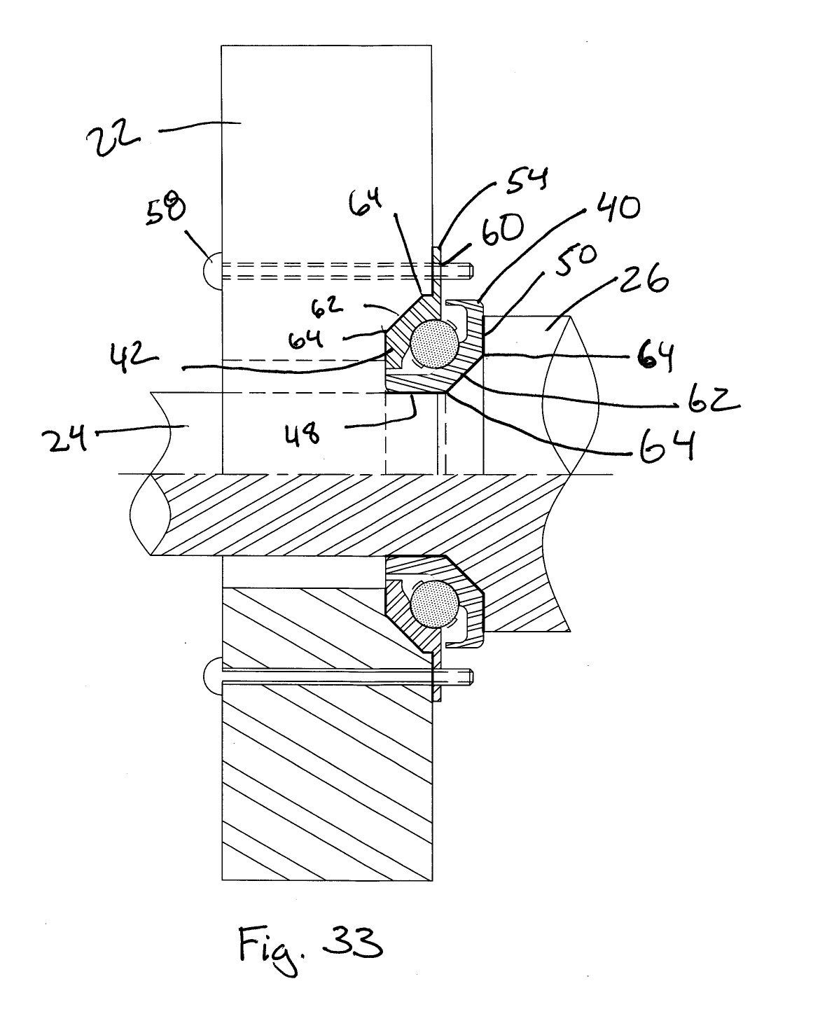

FIGS. 31-33 show schematic diagrams of a bearing assembly 38 of FIGS. 25-27 with threaded holes 60 in the flange 54 as part of the outer race frame 42. FIG. 31 shows a cross-sectional view of the bearing assembly 38, which includes the inner race frame 40, outer race frame 42, balls 44 and ball retainers 46. FIG. 32 shows the normal load 16 and angle α of the normal load 16 for the bearing assembly 38. FIG. 33 shows the bearing assembly 38 mounted in a support frame 22 with shaft 24 and shoulder 26. FIG. 33 also shows bolts 58 inserted into the support frame 22 and the bolts 58 fastened to the threaded holes 60 of the flange 54. The flange 54 of the outer race frame 42 with threaded holes 60 improves the stability of the bearing assembly 38, by allowing the outer race frame 42 to be secured to the support frame 22 with bolts 58.

While different embodiments of the invention have been described in detail herein, it will be appreciated by those skilled in art that various modifications and alternatives to the embodiments could be developed in light of the overall teachings of the disclosure. Accordingly, the particular arrangements are illustrative only and are not limiting as to the scoop of the invention that is to be given the full breadth of any and all equivalents thereof.

We claim:

1. A bearing assembly for a support frame and shaft with a shoulder, comprising:
balls;
an outer race frame with a race to receive balls, said outer race frame adapted to be mounted to said support frame;
an inner race frame with a race to receive said balls, said inner race frame adapted to be mounted to a shaft with a shoulder;
said inner race frame and said outer race frame connected together to encase said balls, said inner race frame and said outer race frame together forming an outside diameter measurement value and inside diameter measurement value of said bearing assembly; and
said inner race including a shoulder surface contact area to be in contact with the shoulder which is at least ninety-five percent of thickness area of the bearing assembly.

2. The bearing assembly of claim 1, wherein said inner race includes a shaft surface contact area which at least ninety-five percent of the width of the bearing assembly about the shaft.

3. The bearing assembly of claim 1, wherein said outer race frame includes a flange about said outer race frame to secure said outer race frame to the support frame.

4. The bearing assembly of claim 3, wherein said outer race frame includes bolt holes.

5. The bearing assembly of claim 4, wherein said outer race frame includes threaded bolt holes.

6. The bearing assembly of claim 2, wherein said outer race frame includes a flange about said outer race frame to secure said outer race frame to the support frame.

7. The bearing assembly of claim 6, wherein said outer race frame includes bolt holes.

8. The bearing assembly of claim 7, wherein said outer race frame includes threaded bolt holes.

9. The bearing assembly of claim 1, wherein said inner race frame includes as part of the shoulder contact surface at least one angled surface to form at least two corners which are intended to contact the shoulder.

10. The bearing assembly of claim 2, wherein said inner race frame includes as part of the shoulder contact surface at least one angled surface to form at least two corners which are intended to contact the shoulder.

11. The bearing assembly of claim 3, wherein said inner race frame includes as part of the shoulder contact surface at least one angled surface to form at least two corners which are intended to contact the shoulder.

12. The bearing assembly of claim 4, wherein said inner race frame includes as part of the shoulder contact surface at least one angled surface to form at least two corners which are intended to contact the shoulder.

13. The bearing assembly of claim 5, wherein said inner race frame includes as part of the shoulder contact surface at least one angled surface to form at least two corners which are intended to contact the shoulder.

14. The bearing assembly of claim 6, wherein said inner race frame includes as part of the shoulder contact surface at least one angled surface to form at least two corners which are intended to contact the shoulder.

15. The bearing assembly of claim 7, wherein said inner race frame includes as part of the shoulder contact surface at least one angled surface to form at least two corners which are intended to contact the shoulder.

16. The bearing assembly of claim 8, wherein said inner race frame includes as part of the shoulder contact surface at least one angled surface to form at least two corners which are intended to contact the shoulder.

17. The bearing assembly of claim 1, wherein said outer race frame includes as part of a contact surface at least one angled surface to form at least two corners which are intended to contact the support frame.

18. The bearing assembly of claim 2, wherein said outer race frame includes as part of a contact surface at least one angled surface to form at least two corners which are intended to contact the support frame.

19. The bearing assembly of claim 3, wherein said outer race frame includes as part of a contact surface at least one angled surface to form at least two corners which are intended to contact the support frame.

20. The bearing assembly of claim 4, wherein said outer race frame includes as part of a contact surface at least one angled surface to form at least two corners which are intended to contact the support frame.

21. The bearing assembly of claim 5, wherein said outer race frame includes as part of a contact surface at least one angled surface to form at least two corners which are intended to contact the support frame.

22. The bearing assembly of claim 6, wherein said outer race frame includes as part of a contact surface at least one angled surface to form at least two corners which are intended to contact the support frame.

23. The bearing assembly of claim 7, wherein said outer race frame includes as part of a contact surface at least one angled surface to form at least two corners which are intended to contact the support frame.

24. The bearing assembly of claim 8, wherein said outer race frame includes as part of a contact surface at least one angled surface to form at least two corners which are intended to contact the support frame.

25. The bearing assembly of claim 1, wherein normal load angle α between stress direction and tangential direction at contact points between said balls and said races of said inner and outer race frames is less than sixty (60) degrees.

26. The bearing assembly of claim 1, wherein normal load angle α between stress direction and tangential direction at contact points between said balls and said races of said inner and outer race frames is less than sixty (60) degrees.

27. The bearing assembly of claim 9, wherein normal load angle α between stress direction and tangential direction at contact points between said balls and said races of said inner and outer race frames is less than sixty (60) degrees.

28. The bearing assembly of claim 17, wherein normal load angle α between stress direction and tangential direction at contact points between said balls and said races of said inner and outer race frames is less than sixty (60) degrees.
